(19) United States
(12) Patent Application Publication
(10) Pub. No.: US 2010/0007684 A1
(43) Pub. Date: Jan. 14, 2010

(54) INK CONTAINER AND INK DISCHARGE DEVICE

(75) Inventor: Keiichiro Watanabe, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/449,002

(22) PCT Filed: Jan. 17, 2008
(86) PCT No.: PCT/JP2008/050516

§ 371 Date: Jul. 16, 2009

(30) Foreign Application Priority Data
Jan. 19, 2007 (JP) 2007-010751

(51) Int. Cl. B41J 2/175

(52) U.S. Cl. 347/6; 347/85

(57) ABSTRACT

A sub-tank (13) is provided in an ink passage which conducts ink from an ink chamber (18) of a main tank (12) to an ink discharge head (11). The sub-tank includes an ink bag (20) and partition plates (52, 54). The ink bag (20) is made of a flexible material, and moreover is made so as to retain ink which flows along the ink passage in its interior. The partition plates (52, 54) are disposed so as to hold the ink bag (20) between them, and restrain the ink bag (20) so that it does not expand to larger than an expanded state which is determined in advance.

### TECHNICAL FIELD

This invention relates to an ink container and to an ink discharge device, which include an ink bag that is provided in an ink passage that conducts ink from an ink containing unit to an ink jet head.

### BACKGROUND ART

It is considered that one of the very important problems with an ink discharge device is to perform stable discharge over a long time period. In order to solve this problem, it is very important to eliminate occurrence of non-discharge to the greatest possible extent. One cause of non-discharge is considered to be air which has become blended into the ink. When dissolved air grows into air bubbles within the ink flow conduit, the ink flow conduit may easily become blocked, and non-discharge may easily occur.

In the prior art, in order to prevent air blending into the ink, it has been practiced to use a sealed type ink bag which is made of a flexible material. And, when such an ink bag is used, often a means for detecting the amount of ink stored in the ink bag has been provided.

For example, among prior art techniques, one has been used in which a sub-ink bag is formed by expanding a portion of an extraction passage through ink is extracted from the ink bag, and the remaining ink amount is detected by optically detecting the change of shape of this sub-ink bag as ink is consumed (for example, refer to Patent Document #1). Furthermore, there is also another technique in which light is irradiated upon a bag on which an aluminum layer is vapor deposited, and it is detected that the remaining amount of ink has dropped below a predetermined value from the intensity of light which is reflected by the surface of the bag (for example, refer to Patent Document #2).

Patent Document #1: Japanese Laid-Open Patent Publication Showa 59-204567.

Patent Document #2: Japanese Laid-Open Patent Publication Heisei 05-169679.

### DISCLOSURE OF INVENTION

### Problems to be Solved by the Invention

If an ink bag is provided in an ink passage which conducts ink from the ink containing unit to the ink jet head, then it is desirable to be able to ascertain the amount of ink which is stored within the ink bag in as accurate a manner as possible. Moreover, it is considered to be desirable for the accuracy with which the amount of ink stored in the ink bag is measured, not to decrease over the entire life of the ink bag.

The object of the present invention is to provide an ink container and an ink discharge device, which are capable of preventing decrease of the accuracy with which the amount of ink stored in the ink bag is measured.

### Means for Solving Problem

(1) The ink container according to the invention of the present application is provided in an ink passage that conducts ink from an ink containing unit to an ink jet head. This ink container includes an ink bag and regulation members. The ink bag is made of a flexible material, and is adapted to store ink flowing along the ink passage in its interior. And the regulation members are disposed on both sides of the ink bag, and regulate the ink bag so that it does not expand to larger than an expanded state which is determined in advance.

The reason for providing the regulation members is that there is a fear that, if the ink bag expands too much, folding and twisting of the ink bag may take place, so that, in subsequent measurements, it may become impossible to ascertain the amount of ink in the interior of the ink bag, in an adequate manner, from the state of expansion of the ink bag. However, by the regulation members regulating the expansion of the ink bag, it becomes possible to prevent the ink bag from expanding so much that folding and twisting of the ink bag occurs.

(2) The ink discharge device according to the invention of the present application discharges ink against an object to be processed. This ink discharge device includes an ink bag, a detection unit, and a control unit. The ink bag is made of a flexible material. Moreover, the ink bag is provided in an ink passage which conducts ink from an ink containing unit to an ink jet head, and is adapted to store ink flowing along the ink passage in its interior. The detection unit detects the expanded state of the ink bag. For example, an optical sensor or a pressure sensor or the like may be cited as possibilities for this detection unit. And the control unit controls flow of ink along the ink passage on the basis of the result of detection by the detection unit. This control unit regulates the flowing of ink into the ink bag, so that the ink bag does not expand to larger than an expanded state which is determined in advance.

By the control unit regulating the flowing of ink into the ink bag in an adequate manner, it becomes possible to prevent the ink bag from expanding so much that folding and twisting of the ink bag occurs. As a result, it becomes possible to prevent the occurrence of malfunctioning, in which, due to folding and twisting of the ink bag taking place, it becomes impossible to ascertain the amount of ink in the interior of the ink bag, in an adequate manner, from the state of expansion of the ink bag.

### EFFECTS OF THE INVENTION

According to the invention of the present application, it becomes possible to prevent decrease of the accuracy by which the amount of ink which is stored in the ink bag is measured.

### BRIEF DESCRIPTION OF THE DRAWINGS

FIG. 1 is a figure showing the general structure of an ink discharge device;

FIG. 2 is a figure showing the general structure of a sub-tank;

FIG. 3 is a figure showing the general structure of a sub-tank;

FIG. 4 is a figure showing an example of the general structure of an optical sensor;

FIG. 5 is a block diagram showing the general structure of an ink discharge device;

FIG. 6 is a figure showing the general structure of an ink bag;

FIG. 7 is a figure showing the general structure of a sub-tank;

FIG. 8 is a figure showing the general structure of a sub-tank;

FIG. 9 is a figure showing the general structure of a sub-tank;

FIG. 10 is a figure showing another example of the structure of an optical sensor; and

FIG. 11 is a figure showing another example of the structure of a sub-tank.

### EXPLANATION OF REFERENCE NUMBERS

10—ink discharge device
11—ink discharge head
12—main tank
13—sub-tank
17—first casing member
19—second casing member
20—ink bag
52, 54—partition plates

### BEST MODE FOR CARRYING OUT THE INVENTION

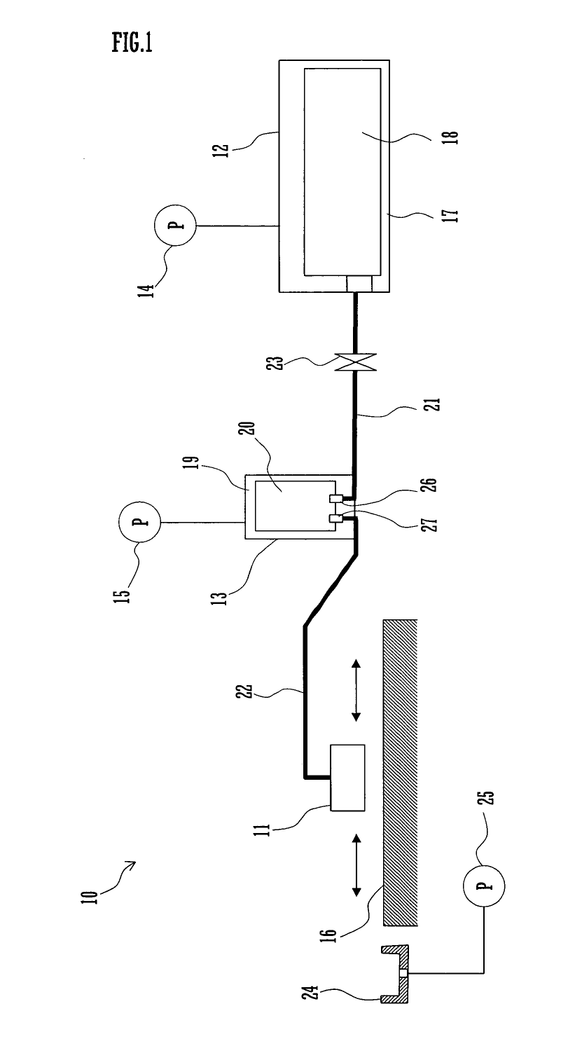

As shown in FIG. 1, an ink discharge device 10 comprises an ink discharge head 11, a main tank 12, and a sub-tank 13. The ink discharge head 11 is supported upon a carriage (not shown in the drawings) so as to shift freely over a stage 16 in the horizontal direction. And the ink discharge head 11 discharges ink towards an object to be processed which is mounted upon the stage 16. As one representative example of an object to be processed, a sheet of blank paper stock or the like upon which an image is to be recorded may be cited. However, the object to be processed is not to be considered as being limited to being a recording medium. As other examples of objects to be processed, cloth, a glass plate, a silicon substrate, and a resin material (plastic) may be contemplated.

Below the range of movement of the ink discharge head 11, a cap 24 is provided so as to be in line with the stage 16. A pressure reduction pump 25 is connected to this cap 24. Ink is discharged from the ink discharge head 11 by operating the pressure reduction pump 25 when the ink discharge head 11 is positioned directly above the cap 24.

The main tank 12 supplies ink to the ink discharge head 11 via an ink passage. The main tank 12 comprises an ink chamber 18 and a first casing member 17. The ink chamber 18 is made of a film which is flexible. And, in order to define a pressure chamber in its interior, the first casing member 17 is made so as to have high airtightness, and is made so that, along with containing the ink chamber 18 in its interior, it demarcates a pressure chamber which is to be formed around the ink chamber 18. A pressurization pump 14 is connected to the first casing member 17. This pressurization pump 14 regulates the air pressure within the first casing member 17. For example, ink within the ink chamber 18 flows out due to the pressurization pump 14 raising the air pressure within the first casing member 17.

The main tank 12 is built so as to be freely fitted and removed to the main body of this ink discharge device 10. Moreover, this main tank 12 is provided with an ink remaining amount detector (not shown in the drawings) and a notification means (also not shown in the drawings) for, when the remaining amount of ink within the main tank 12 has become less than a predetermined amount, issuing a notification to that effect to the user. It should be understood that the user who has received this notification by the notification unit then performs the task of exchanging the present main tank 12 for another main tank which is loaded with ink.

The sub-tank 13 is provided in an ink passage which conducts ink from the main tank 12 to the ink discharge head 11. This sub-tank 13 comprises an ink bag 20 and a second casing member 19. The ink bag 20 is made of a flexible material, and ink which is passing along the ink passage is stored in its interior. The second casing member 19 is made so as to have high airtightness in order to define a pressure chamber in its interior, and is made so that, along with containing the ink bag 20 in its interior, it demarcates a pressure chamber which is to be formed around the ink bag 20. A pressure reduction pump 15 is connected to the second casing member 19. This pressure reduction pump 15 regulates the air pressure within the second casing member 19. For example, a negative pressure may be created in the ink discharge portion of the ink discharge head 11 by the pressure reduction pump 15 lowering the air pressure within the second casing member 19.

However, the technique for creating a negative pressure in the ink discharge portion of the ink discharge head 11 is not limited to the method of reducing the pressure within the second casing member 19. For example, it would also be possible to create a negative pressure in the ink discharge portion of the ink discharge head 11 by arranging the ink bag 20 at a position which is lower than that of the ink discharge head 11. Moreover since, in this case, it is not necessary to reduce the pressure within the second casing member 19, accordingly the pressure reduction pump 15 becomes unnecessary. Yet further, since it becomes unnecessary to seal the second casing member 19, accordingly it becomes possible to simplify the structure of the second casing member 19.

The sub-tank 13 has a first aperture 26 and a second aperture 27. This first aperture 26 and second aperture 27 are disposed at spots which are open to the exterior, and can be connected to ink supply tubes 21 and 22 from the exterior. The first aperture 26 is connected to the main tank 12 via an ink supply tube 21. A valve 23 is provided partway along the ink supply tube 21. The opening and closing operation of this valve 23 is controlled by a drive unit not shown in the figures. And the second aperture 27 is connected to the ink discharge head 11 via an ink supply tube 22.

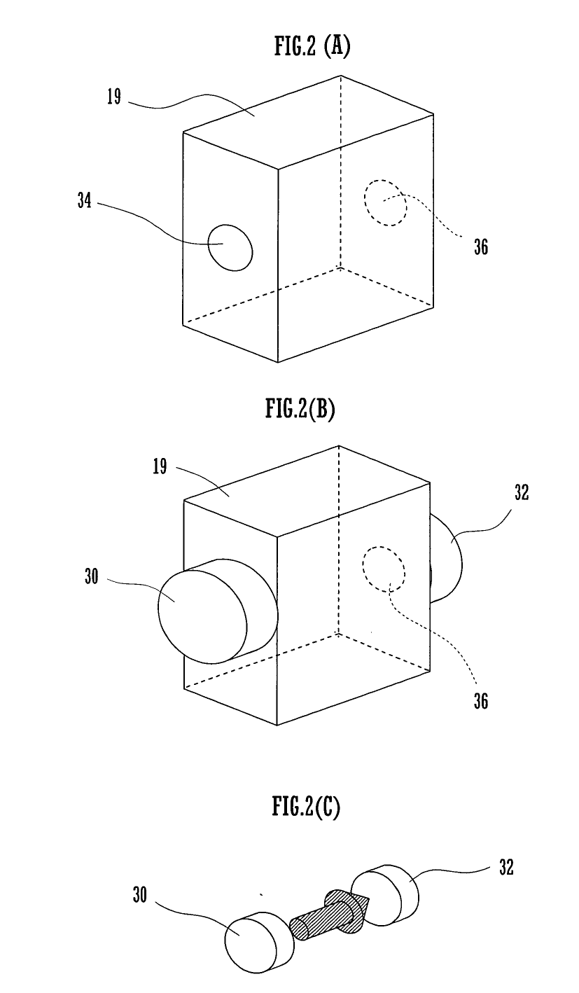

FIG. 2(A) shows the external appearance of the second casing member 19. This second casing member 19 is made of a material which is transparent to light, and has a first window 34 and a second window 36. In this embodiment, the first window 34 and the second window 36 are made of transparent glass. Preferably, a glass which is coated with an attenuation prevention coating should be used for the first window 34 and the second window 36. As shown in FIG. 2(B), a light emission unit 30 is provided so as to cover over the first window 34 from the exterior, and a light reception unit 32 is provided so as to cover over the second window 36 from the exterior. And, as shown in FIG. 2(C), the light emission unit 30 emits light towards the light reception unit 32. The light which is emitted by the light emission unit 30 arrives at the light reception unit 32 via the first window 34, the interior of the second casing member 19, and the second window 36. And the light reception unit 32 detects the state of light reception of the light from the light emission unit 30. As examples of the parameters by which the state of light reception may be decided, the received light intensity, the received light beam width, the surface area of the received light beam, or the spot at which light is received may be cited. It should be understood that, in this embodiment, the sub-tank 13 constitutes the “ink container” of the present invention. Moreover, the light emission unit 30 and the light reception unit 32 correspond to the “optical sensor” of the present invention. The reason for using this optical sensor is that it becomes possible to make the second casing member 19 more compact by disposing the sensor at the exterior of the second casing member 19. Moreover there is the consideration that, if the sensor were to be disposed in the internal space of the second casing member 19 which is sealed, then the wiring task for this sensor would become difficult.

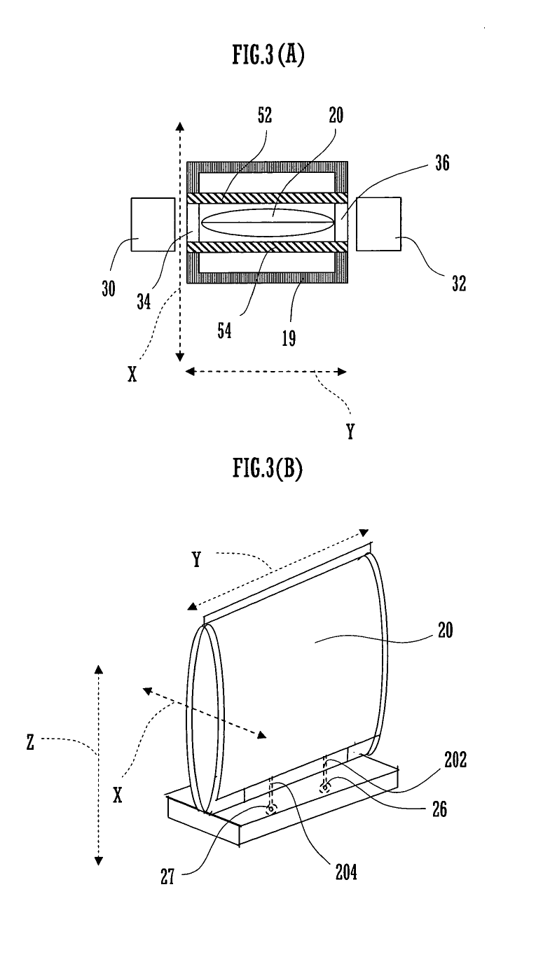

The structure of the ink bag 20 will now be explained using FIGS. 3(A) and 3(B). As shown in FIGS. 3(A) and 3(B), this ink bag 20 is arranged in a vertical orientation within the second casing member 19. The ink bag 20 is positionally determined at a predetermined spot in the interior of the second casing member 19 by a holding member not shown in the figures. In FIGS. 3(A) and 3(B), the arrow signs X, Y, and Z respectively denote the width axis, the length axis, and the height axis of the ink bag 20.

This ink bag 20 is made by connecting together the edges of two thin rectangular sheets which are made of a combination of resin and metal layers. When detecting the expanded state of the ink bag 20 by the optical sensor, it is desirable for the ink bag 20 to be made of a material which is not transparent. An ink inlet aperture 202 and an ink outlet aperture 204 are formed in the bottom edge of the ink bag 20, and respectively communicate with the first aperture 26 and the second aperture 27. The width of the ink bag 20 expands or contracts according to the inflow and outflow of ink. The light emission unit 30 and the light reception unit 32 are arranged on the two sides of the ink bag 20, so as to detect the width of the ink bag 20. Moreover, as shown in FIG. 3(A), partition plates 52 and 54 are disposed within the second casing member 19, for regulating excessive expansion of the width of the ink bag 20. It is desirable for it to be arranged for these partition plates 52 and 54 to absorb light. Here black colored members are used for the partition plates 52 and 54. The reason for providing the partition plates 52 and 54 is in order to prevent deformation of the ink bag 20. As one example of how the ink bag 20 might become deformed, the sides of the ink bag becoming concave may be cited. If a concavity temporarily occurs in one side of the ink bag 20, then the malfunction may occur that the ink bag 20 becomes folded and twisted. Since, in the case of an ink bag 20 which is folded and twisted, the correlation relationship between its width and the amount of ink stored in its interior can easily be lost, accordingly it becomes difficult to detect the amount of ink stored in its interior from its width. Here, by preventing excessive expansion of the width of the ink bag 20, the partition plates 52 and 54 act to prevent the occurrence of folding and twisting of the ink bag 20.

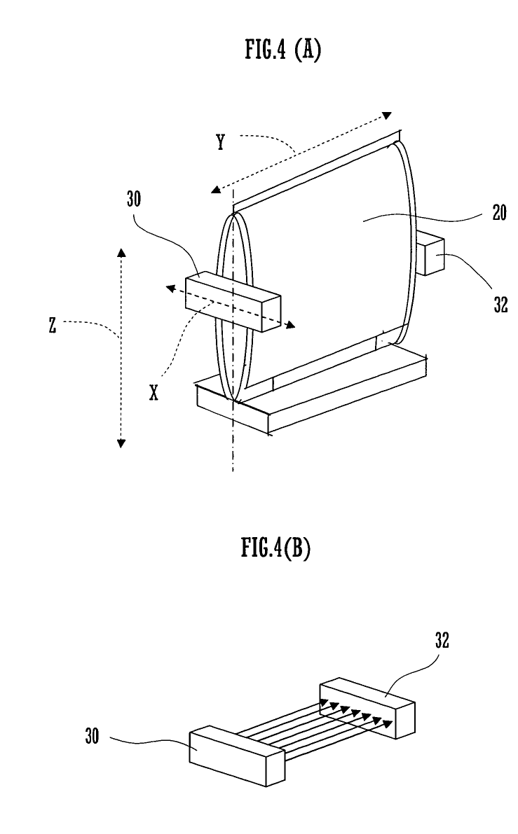

The structure of the light emission unit 30 and the light reception unit 32 will now be explained using FIGS. 4(A) and 4(B). The light emission unit 30 includes a plurality of light emitting elements which are arranged in a line. This array of light emitting elements is set so as to lie along the width axis of the ink bag 20. Although in this embodiment a linear light source is used as the light emission unit 30, it would also be possible to utilize a point light source or a planar light source. And the light reception unit 32 detects the width of the received light beam emitted by the light emission unit 30. It is desirable for the widths of the widths of the light emission unit 30 and the light reception unit 32 to be greater than the width of the ink bag when the maximum limit amount of ink is stored in it. LV-H300 units made by Keyence Co. may be used as the light emission unit 30 and the light reception unit 32.

When the width of the ink bag 20 decreases due to ink flowing out from the ink bag 20, the width of the light beam received by the light reception unit 32 increases. On the other hand, when the width of the ink bag 20 increases due to ink flowing into the ink bag 20, the width of the light beam received by the light reception unit 32 decreases. In this embodiment, a structure is employed which detects the state of expansion of the ink bag 20 by detecting the change of the width of the light beam received by the light reception unit 32. Since, with this type of structure, it becomes possible to perceive the expanded state of the ink bag 20 directly, accordingly it becomes possible to obtain the amount of ink stored in the ink bag 20 more accurately, as compared to a structure in which the intensity of the received light beam is detected.

It is desirable for the light emission unit 30, the light reception unit 32, the first window 34, and the second window 36 to be arranged at the central portion of the ink bag 20 along the height axis. The reason for this is that the central portion of the ink bag 20 along its height axis is the portion at which the change of width along with inflow and outflow of ink is the largest. By providing this arrangement, it accordingly becomes possible to assess the change of the width of the ink bag 20 with good accuracy.

It should be understood that it is not essential for the sensor for detecting the expanded state of the ink bag 20 to be an optical sensor; it would also be possible to utilize a sensor of some other type. For example, instead of an optical sensor, it would be possible to utilize a pressure sensor which detects the intensity of the contact forces which press against the partition plates 52 and 54 from the ink bag 20.

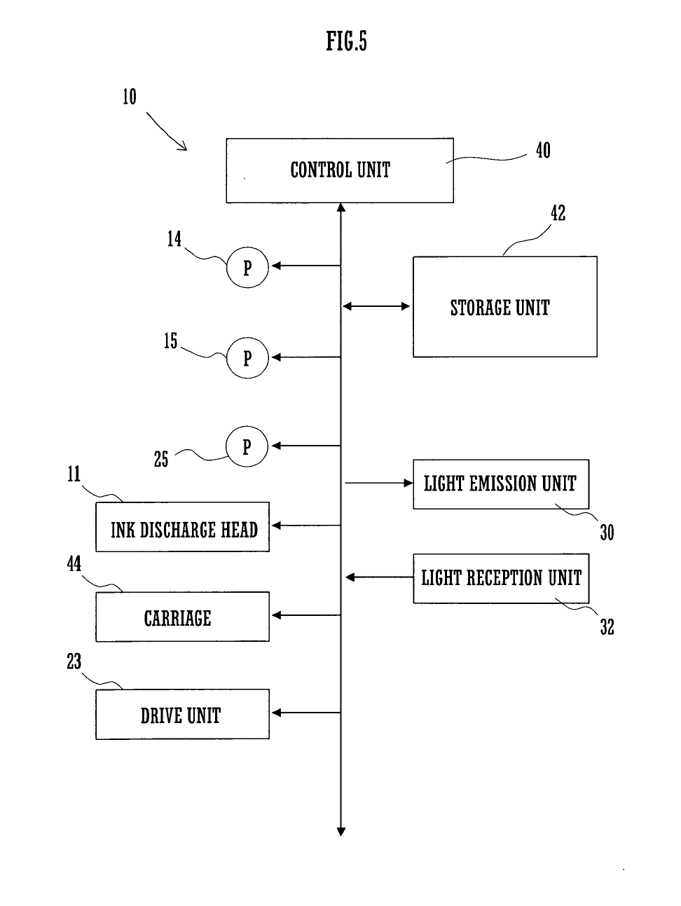

FIG. 5 is a block diagram showing the general structure of the ink discharge head 10. This ink discharge head 10 includes a control unit 40. The control unit 40 controls the operation of the pressurization pump 14, the pressure reduction pump 15, the pressure reduction pump 25, the ink discharge head 11, and the light emission unit 30. Moreover, this control unit 40 controls the operation of the carriage 44 to shift the ink discharge head 11 over the stage 16, and the operation of the drive unit 23 which performs opening and closing of the valve 23.

Furthermore, the control unit detects the about of ink which is stored in the ink bag 2 according to the state of light reception as detected by the light reception unit 32. In this embodiment, the control unit 40 detects the amount of ink stored in the ink bag 20 by using an ink remaining amount conversion table which is recorded in the storage unit 42. This ink remaining amount conversion table consists of a correspondence relationship between the width of the light beam received by the light reception unit 32 and the amount of ink stored in the ink bag 20, which is obtained from information acquired by measurement in advance.

The control unit 40 performs control so as to prevent excessive expansion of the ink bag 20. In concrete terms, when as a result of ink flowing into the ink bag 20 the width of the ink bag 20 has arrived at a threshold value which is set in advance, the control unit 40 stops the inflow of ink into the ink bag 20. This threshold value is set to around 80% of the maximum ink holding capacity of the ink bag 20, as a rough estimate. In this embodiment, the maximum ink holding capacity of the ink bag 20 is 15 cc, and this threshold value is 12 cc. Due to this, when it is detected that the width of the ink bag 20 has arrived at a magnitude which corresponds to a stored ink amount of 12 cc, the control unit 40 stops the inflow of ink into the ink bag 20.

Moreover, the gap between the partition plates 52 and 54 is determined so that, when the amount of ink stored in the ink bag 20 reaches 12 cc, the expansion of the ink bag 20 is suppressed by the partition plates 52 and 54. Due to this it is possible to prevent the flowing of more ink than 12 cc into the ink bag 20, even if, for example, the control unit 40 should operate wrongly.

On the other hand, when the control unit 40 detects that the amount of ink stored in the ink bag 20 is insufficient, it causes ink to flow in to the ink bag 20 by operating the pressurization pump 14.

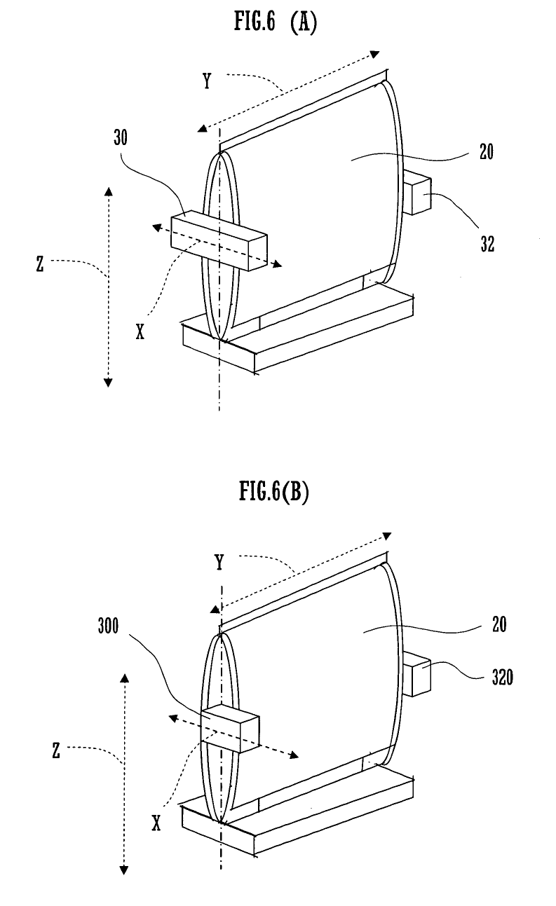

In this first embodiment, as shown in FIG. 6(A), an optical sensor is used whose width is wider than that of the ink bag 20. Instead of this type of structure it would also be possible, as shown in FIG. 6(B), to detect the expanded state of the ink bag 20 only on one side thereof along its widthwise axis, by using an optical sensor which is shorter than the width of the ink bag. As one example of an optical sensor which may be used with the structure shown in FIG. 6(B), there may be cited the LV-H100 made by Keyence Co. This optical sensor consists of a light emission unit 300 and a light emission unit [sic] 320. It will be sufficient for the widths of the light emission unit 300 and the light emission unit 320 [sic] to be greater than half of the maximum expansion width of the ink bag 20. Since normally the change of the width of the ink bag 20 is symmetric about its center, it is possible to detect the amount of ink which is stored in the ink bag 20 in an accurate manner, even if the detection is performed at only one side thereof along its width axis. According to this type of structure, it becomes possible to lower the production cost of the ink discharge device 10, since the sensor may be a compact one.

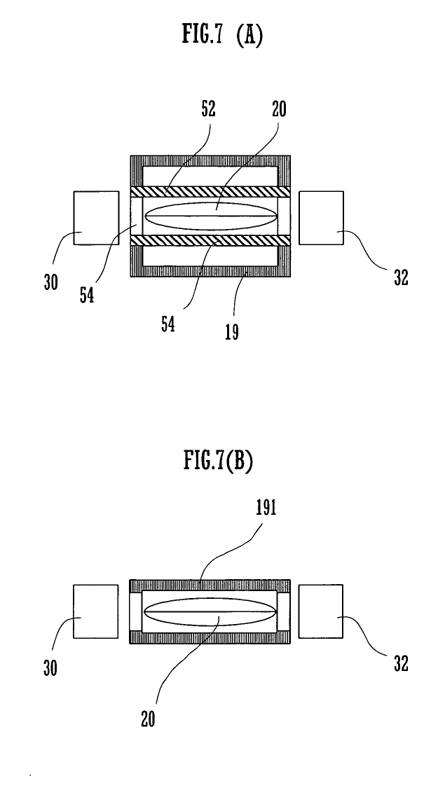

Moreover, in the first embodiment, as shown in FIG. 7(A), a structure was employed in which the partition plates 52 and 54 were provided separately from the second casing member 19. However, instead of this type of structure, it would also be acceptable to utilize a casing member 191 which has the function of regulating the expansion of the ink bag 20, as shown in FIG. 7(B). This casing member 191 fulfils the functions of all of the casing member, the partition plate 52, and the partition plate 54 of the first embodiment. In this case, it is desirable for the inner walls of the casing member 191 to be colored black. The reason why is that, if light is absorbed by these inner walls of the casing member 191, then it is possible to prevent light which is reflected by the inner walls of the casing member 191 from arriving at the light reception unit 32.

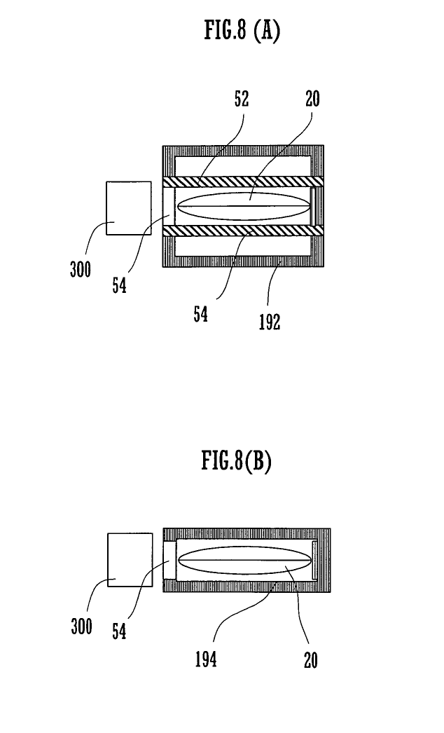

Although a transmission type optical type optical sensor was used in the first embodiment, it would also be possible, as shown in FIGS. 8(A) and 8(B), to substitute an optical sensor 300 of the reflective type. With this structure, it will be sufficient to provide only a single window in the casing member 192 or 194.

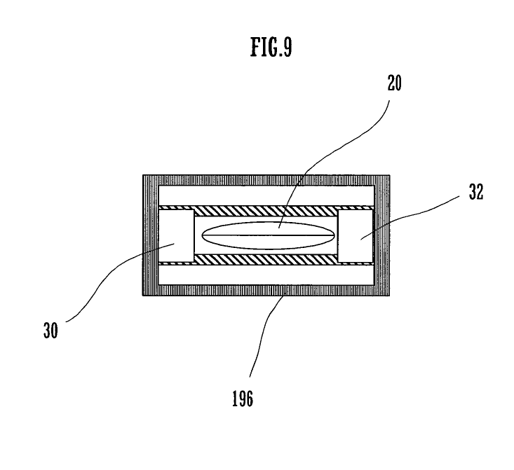

While, in the first embodiment, the light emission unit 30 and the light reception unit 32 were disposed exterior to the second casing member 19, the positions in which the light emission unit 30 and the light reception unit 32 are disposed are not limited to this arrangement. For example it would also be possible, as shown in FIG. 9, to dispose the light emission unit 30 and the light reception unit 32 interior to a casing member 196. With this structure it becomes possible to detect the width of the ink bag 20 more reliably, since the light for detecting the width of the ink bag 20 does not pass through any window.

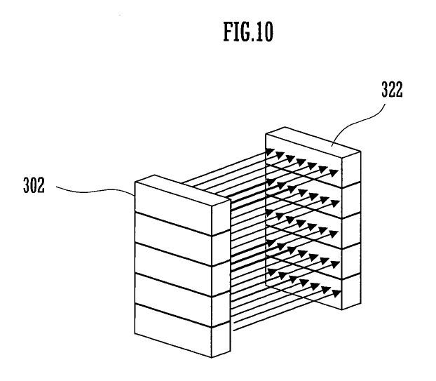

FIG. 10 shows an example of the use of an area sensor which can measure the light reception surface area of a light reception unit upon which light is being received. As an example of the structure of such an area sensor, it is suggested to use a MCBP-CW3430 made by Moritex Co. as a light emission unit 302, and to use a IV-S20 made by Sharp Co. as a light reception unit 322. Since, with this structure, the amount of light intercepted by the ink bag 20 increases along with expansion of the ink bag 20, accordingly the area upon the light reception unit 322 over which light is received decreases. Thus the amount of ink stored in the ink bag 20 is detected by detecting change of the area of the light reception surface of the light reception unit 322 which is illuminated.

Since it is possible to detect the influence of expansion of the ink bag 20 over a wide range, accordingly it is possible to detect the amount of ink which is stored in the ink bag 20 more accurately, as compared to the use of a line sensor. It should be understood that, if the light emission unit 302 is a parallel light source, then the amount of light which gets around the ink bag 20 is reduced, and it becomes easy to clarify the relationship between the degree of expansion of the ink bag and the surface area which is receiving illumination.

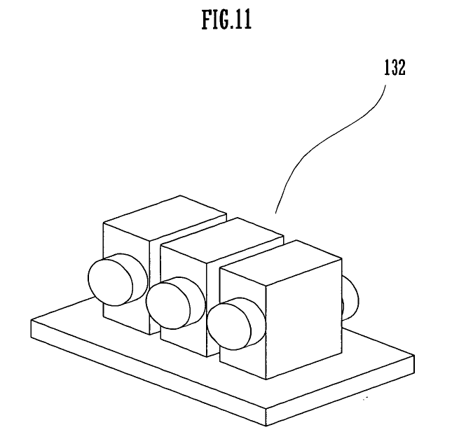

FIG. 11 is a figure showing the general structure of a sub-tank unit 132. This sub-tank unit 132 has a structure in which a plurality of the sub-tanks 13 described above are integrally provided in a row. In FIG. 11, an example is shown in which three sub-tanks 13 constitute a single sub-tank unit 132. The reason that this type of structure is employed is that it makes it easy to handle the plurality of ink bags 20 all together.

Since, with this structure, the ink bag is arranged in a vertical orientation, accordingly it becomes possible to dispose a large number of ink bags 20 in a smaller space, as compared to a configuration in which the ink bag 20 is oriented horizontally.

It should be understood that it would also be possible to receive a plurality of ink bags 20 in a single casing member. In this case, a single pressure reduction pump for reducing the pressure within the casing member will be sufficient. Moreover, it also becomes possible to provide only one window which is transparent to the light of the optical sensor for entry, and only one such window for exit. With this type of structure, it is desirable to partition off between the plurality of ink bags 20 with individual partition plates. And it is desirable, in this case, for the partition plates to be colored black so as to absorb light.

All of the features of the explanation of this embodiment given above are given by way of example, and must not be viewed as being limitative of the present invention in any way. The scope of the present invention is not defined by the embodiment described above, but only by the range of the Claims. Moreover, all changes which are equivalent in meaning and scope to the scope of the Claims, are intended to be included within the range of the present invention.

1. An ink container provided in an ink passage that conducts ink from an ink containing unit to an ink jet head, the ink container comprising:
an ink bag adapted to store ink flowing along the ink passage therein, the ink bag being made of a flexible material; and
regulation members for regulating the ink bag in such a manner that the ink bag does not expand to larger than a predetermined expanded state, the regulation members being disposed on both sides of the ink bag.

2. An ink discharge device adapted to discharge ink against an object to be processed, the device comprising:
an ink bag provided in an ink passage which conducts ink from an ink containing unit to an ink jet head, the ink bag being adapted to store ink flowing along the ink passage therein, the ink passage being made of a flexible material;
a detection unit adapted to detect expanded state of the ink bag; and
a control unit configured to control flow of ink along the ink passage corresponding to the result of detection by the detection unit;
wherein the control unit regulates the flowing of ink into the ink bag in such a manner that the ink bag does not expand to larger than a predetermined expanded state.

3. An ink discharge device according to claim 2, further comprising regulation members for regulating the ink bag in such a manner that the ink bag does not expand to larger than a predetermined expanded state, the regulation members being disposed on both sides of the ink bag.

4. An ink discharge device according to claim 3, further comprising a casing member adapted to contain the ink bag therein, the casing member defining a pressure chamber to encompass the ink bag,
wherein the detection unit is an optical sensor disposed at the exterior of the casing member.

5. An ink discharge device according to claim 4, wherein the optical sensor comprises a light emission unit adapted to irradiate light towards the ink bag, and a light reception unit adapted to detect the width of a received light beam from the light emission unit,
and wherein the control unit detects the width of the ink bag on the basis of the width of the light beam detected by the light reception unit.

6. An ink discharge device according to claim 5, wherein the control unit detects the amount of ink stored in the ink bag on the basis of the width of the light beam detected by the light reception unit.

7. An ink discharge device according to claim 5, wherein the optical sensor is adapted to perform detection over the entire width of the ink bag.

8. An ink discharge device according to claim 5, wherein the optical sensor is adapted to perform detection over one half of the width of the ink bag from its center in its widthwise direction.

9. An ink discharge device according to claim 3, wherein an ink inlet of the ink bag is disposed in a downwards orientation with respect to the direction of gravity.

10. An ink discharge device according to claim 9, wherein the optical sensor is arranged in such a manner that, when an ink inlet of the ink bag is oriented downwards with respect to the direction of gravity, the optical sensor detects the width of a center portion of the ink bag in its height direction.
